(19) United States
(12) Patent Application Publication
(10) Pub. No.: US 2008/0314349 A1
(43) Pub. Date: Dec. 25, 2008

(54) Green start engine control systems and methods

(75) Inventors: Heiko Oertel, Wolverine Lake, MI (US); Peter Knieps, Novi, MI (US)

Correspondence Address: MICHAEL BEST & FRIEDRICH LLP, 100 EAST WISCONSIN AVENUE, MILWAUKEE, WI, 53202, US

(73) Assignee: Robert Bosch GmbH

(21) Appl. No.: 11/821,668

(22) Filed: Jun. 25, 2007

(51) Int. Cl. F02N 17/00

(52) U.S. Cl. 123/179.5; 123/179.16; 123/179.3; 123/179.7

(57) ABSTRACT

A method of starting an engine having a fuel rail, one or more fuel injectors, and one or more spark plugs. In one embodiment, the method includes initializing a starting operation of the engine and suppressing the engine from starting by retarding a spark timing of the one or more spark plugs from normal spark timing. The method also includes purging, while the spark timing is being retarded, the fuel rail of the engine by operating the one or more fuel injectors. Additionally, the method includes advancing the spark timing after a first duration has passed or the engine has started.

### FIELD

The invention relates to systems and methods for controlling an engine. More specifically, the invention relates to systems and methods for controlling an engine during an initial or “green” start.

### BACKGROUND

Vehicles are commonly assembled using an assembly line process, and tested prior to being sold. For example, an initial or “green” test of an engine is performed before the assembled vehicle is released from the assembly line. In some instances, components associated with the assembled vehicle, such as the engine, are also subjected to a variety of additional tests prior to vehicle assembly. For example, the engine of a vehicle may be subjected to an initial battery of tests after being manufactured.

An initial engine test may affect subsequent tests, such as the green test. For example, the initial test of an engine during manufacture can require fuel to be supplied to the engine. As a result, residual fuel may be present in the engine after the initial test is completed. This residual fuel may cause problems in subsequent tests. For example, residual fuel from an initial test may cause the engine to start and then stall during an initial or green start after the engine is assembled in a vehicle body. Engines that stall on the assembly line during a green start are typically removed from the assembly line and inspected manually, increasing associated time and labor costs.

### SUMMARY

In one embodiment, the invention provides a method of starting an engine having a fuel rail, one or more fuel injectors, and one or more spark plugs. The method includes initializing a starting operation of the engine and suppressing the engine from starting by retarding a spark timing of the one or more spark plugs from normal spark timing. The method also includes purging, while the spark timing is being retarded, the fuel rail of the engine by operating the one or more fuel injectors. Additionally, the method includes advancing the spark timing after a first duration has passed or the engine has started.

In another embodiment, the invention provides a method of starting an engine having a fuel injection system. The engine is installed in a vehicle having an associated fuel line and fuel tank, the fuel injection system and fuel line are initially filled with air. The method includes initializing a starting operation of the engine. The fuel injection system of the engine includes a fuel rail having residual fuel disposed therein. The method also includes retarding a spark timing of one or more spark plugs included in the fuel injection system, purging air from of the fuel line and burning residual fuel from the fuel rail, and supplying the fuel rail with fuel from the fuel tank via the fuel line. Additionally, the method includes advancing the spark timing of the one or more spark plugs included in the fuel injection system upon the engine of the vehicle starting based on fuel delivered to fuel injectors of the fuel injection system from the fuel tank of the vehicle.

In yet another embodiment, the invention provides a method of starting an engine of a vehicle. The engine has a fuel injection system. The vehicle has a fuel tank and a fuel line that is configured to supply the fuel injection system of the engine with fuel from the fuel tank. The method includes initiating a green start process. The method also includes initiating ignition of the engine, retarding a spark timing of spark plugs included in the engine for a first period of time. Additionally, the method includes advancing the spark timing after the first period of time, starting the engine of the vehicle upon the spark timing being advanced, and supporting an idle operation of the engine by altering spark parameters of the spark plugs.

Other aspects of the invention will become apparent by consideration of the detailed description and accompanying drawings.

### BRIEF DESCRIPTION OF THE DRAWINGS

FIG. 1 schematically illustrates a vehicle.

FIG. 2 illustrates an exemplary process for testing an engine.

FIG. 3 illustrates an exemplary embodiment of an engine control system.

FIG. 4 illustrates an exemplary process for supporting an engine during testing.

FIG. 5 illustrates an exemplary process for controlling spark timing.

FIG. 6 illustrates another exemplary process for controlling spark timing.

FIG. 7 illustrates an exemplary process for controlling spark boundaries.

FIG. 8 illustrates an exemplary engine.

FIG. 9 illustrates an exemplary table of fuel injector operational ratios.

FIG. 10 illustrates an exemplary plot of engine revolutions per minute (“RPM”) over time.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

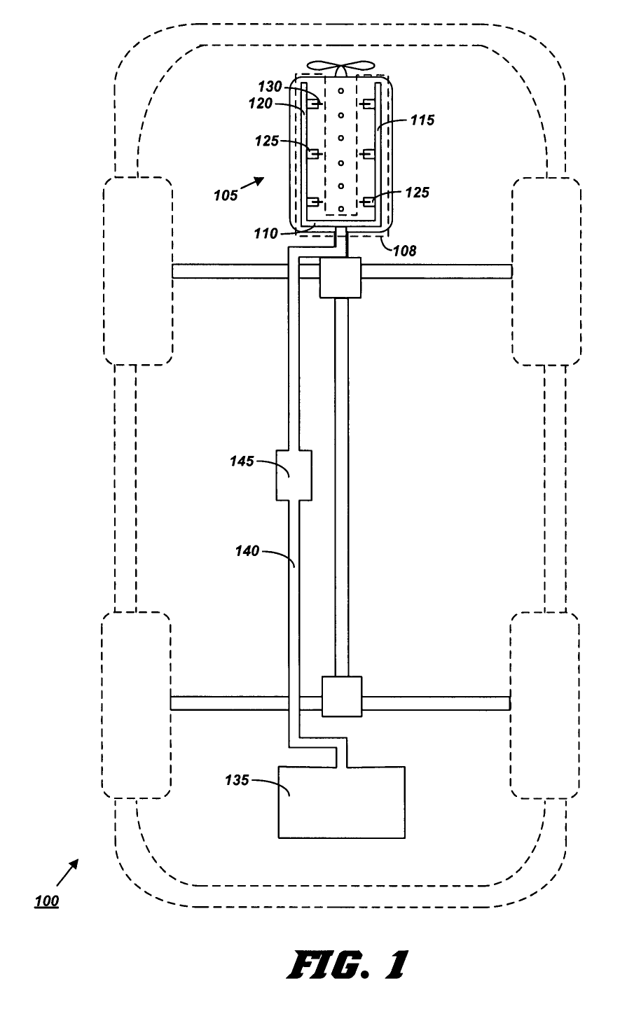

FIG. 1 illustrates an exemplary vehicle 100. The vehicle 100 can be manufactured in a factory or other suitable facility. In some embodiments, the vehicle 100 is tested prior to being released from the factory. For example, as described in greater detail below, the operation of the vehicle is tested to ensure that all of the components of the vehicle are functioning properly. Additionally, vehicle components are often tested individually and as sub-assemblies to ensure proper operation, as well as compatibility with each other (e.g., components of a fuel system are functioning properly with the engine).

In the embodiment shown in FIG. 1, the vehicle 100 includes an engine 105 having a fuel injection system 108. The fuel injection system 108 includes a fuel rail 110 having a first bank 115 and a second bank 120. The fuel injection system 108 also includes a plurality of fuel injectors 125, as well as spark plugs 130 positioned near the fuel injectors 125. There are six fuel injectors 125 (and respective spark plugs 130) shown in FIG. 1. However, in other embodiments, more of fewer fuel injectors 125 may be included in the fuel injection system 108 (e.g., four injectors, eight injectors, etc.).

A brief and basic review of fuel injection systems is provided. Nonetheless, it is assumed that the reader is familiar with fuel injection systems for vehicles. The fuel rail 110 supplies fuel to fuel injectors 125. The fuel injectors 125 then disperse fuel into cylinders of the engine 105, which is subsequently ignited by the spark plugs 130. This combustion drives pistons within the engine cylinders, which ultimately produces a usable force. The pistons are driven up and down within the cylinders of the engine several times a second. For example, the fuel injectors 125 disperse the fuel into the cylinders of the engine 105, and the spark plugs ignite the dispersed fuel several times per second. These actions must be synchronized with the position of the pistons to produce an efficient combustion and corresponding resultant force. A “spark timing,” or, more simply, “timing” generally refers to the position of the piston at the time a spark event occurs (i.e., the spark plug is fired). For example, a normal spark plug timing may be 20 degrees before top dead center (“TDC”). In some instances, spark timing can be advanced (e.g., the spark event occurs further in front of TDC), or retarded (e.g., the spark event occurs closer to, or after, TDC), which affects the efficiency and performance of the engine 105.

Fuel is provided to the fuel rail 110 of the engine 105 from a fuel tank 135. Fuel travels from the tank 135 through a fuel line 140. A fuel pump 145 draws the fuel from the fuel tank 135 and propels it to the engine 105. When the components of the fuel system (e.g., the fuel tank 135, the fuel line 140, and the fuel pump 145) are assembled, for example, in a manufacturing facility, the components are generally void of fuel.

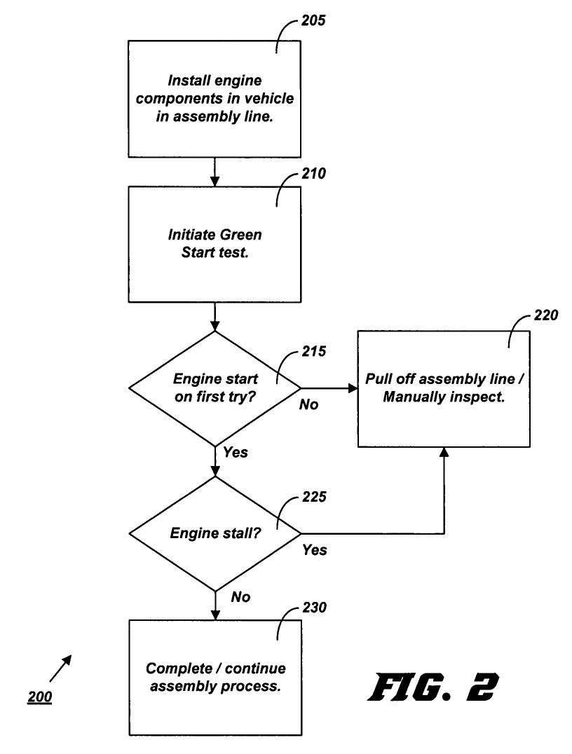

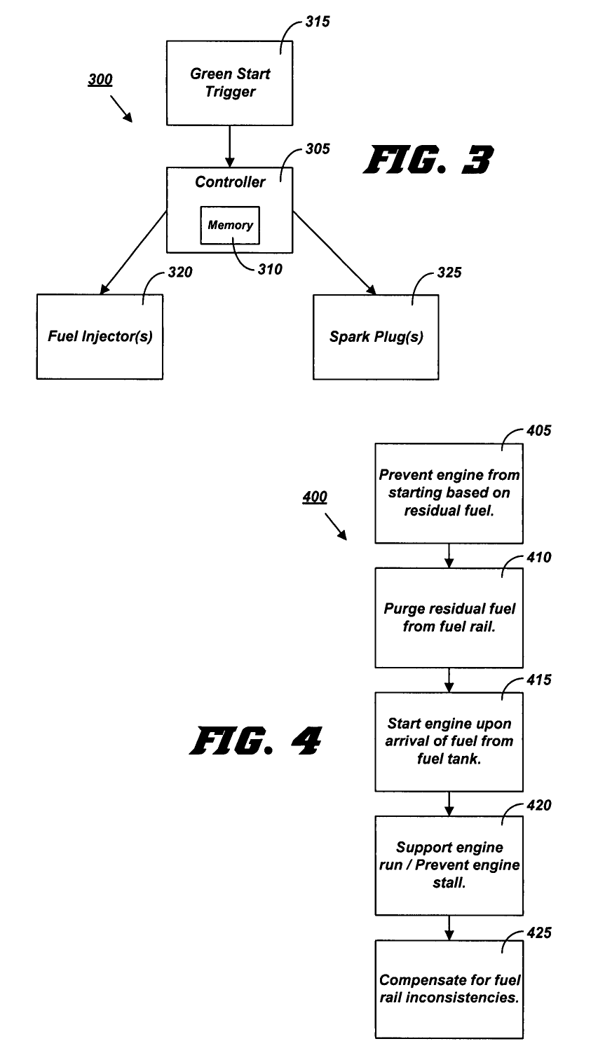

FIG. 2 illustrates a process 200 for testing functions or operations of a vehicle. For purposes of clarity, the process 200 is described as being carried out with the vehicle 100 (see FIG. 1). The first step in the process 200 is to install the engine 105 and associated components (e.g., fuel line 140, fuel pump 145, fuel tank 135, etc.) in the vehicle 100 (step 205). After the vehicle 100, or at least a portion thereof, has been assembled, an initial or “green start” can be initiated (step 210). As described herein, a “green start” includes, for example, actuating an ignition sequence (e.g., turning an ignition key), thereby starting the engine 105 of the vehicle 100 after the vehicle 100 has been assembled. This does not mean that components of the vehicle 100 have not been independently and previously tested prior to the green start. For example, the engine 105 of the vehicle 100 may be initially tested on an engine stand prior to being installed in the vehicle 100. Rather, the green start is used to provide an indication that the engine and associated components (e.g., the components of the fuel system) are properly installed in a vehicle and operating properly.

In some instances, the engine 105 of the vehicle 100 does not start during a green start due to lack of fuel in the fuel rail 110 and/or fuel line 140. As should be apparent, when first assembled the fuel rail 110 and fuel line 140 are void of fuel during assembly. Before the engine 105 will start, the empty components must be provided with fuel and purged of air within them. In other instances, the engine 105 of the vehicle 100 starts immediately during a green start, but stalls soon thereafter. Generally, an immediate engine start followed by a stall is due to residual fuel (e.g., fuel or a fuel/air mixture that remains in the fuel rail 110 from previous engine tests, which cannot be efficiently purged) being burned and causing the engine 105 to start. Often, the residual fuel is followed by air from the initially empty fuel line 140, which causes the engine 105 to stall.

If the engine 105 of the vehicle 100 does not start during the green start (step 215), the vehicle 100 is removed from the assembly line and manually inspected (step 220). If the vehicle 100 starts during the initial stage of the green start, the continued or idling operation of the engine 105 is verified (step 225). If the engine of the vehicle stalls during the idle operation, the vehicle 100 is removed from the assembly line and manually inspected (step 220). If, however, the engine 105 of the vehicle 100 continues to run, the assembly process continues (step 230). If the green start is the final step in the assembly process, the process 200 ends (also step 230). Generally, manually removing vehicles 100 from the assembly line and/or manually inspecting the vehicles 100 is inefficient and costly.

While the process 200 is described as being carried out on the vehicle 100 (generally represented as a automobile), it should be apparent to one of ordinary skill in the art that the systems and methods described herein could be implemented to test a variety of engines installed in a variety of vehicles (e.g., lawnmowers, all terrain vehicles (“ATVs”), snowmobiles, motorcycles, etc.).

FIG. 3 illustrates an exemplary embodiment of at least a portion of an engine control system 300. The engine control system 300 includes a controller 305 having memory 310, a green start trigger 315, one or more electronically controlled fuel injectors 320, and one or more spark plugs 325. In some embodiments, the engine control system 300 may include more or fewer components than those shown in FIG. 3. For example, in some embodiments, the engine control system 300 also includes additional triggers, timers, sensors, actuators, and the like. In other embodiments, the engine control system 300 does not include a green start trigger 315, as described in greater detail below.

The controller 305 is a suitable device, such as, for example, a microprocessor, a computer, a programmable logic controller (“PLC”), or other similar device. As such, the controller 305 may include both hardware and software components, and is meant to broadly encompass combinations of such components. The memory 310 can be implemented using a variety of different types of memory, such as, for example, random-access memory (“RAM”), read-only memory (“ROM”), flash memory, and the like. In the embodiment shown in FIG. 3, the memory 310 is incorporated into the controller 305. However, in other embodiments, the memory 310 may be included in a structure separate from the controller 305, which communicates with the controller 305 via a bus (e.g., a CAN bus). Generally, the controller 305 executes a variety of processes (e.g., as shown and described with respect to FIGS. 4-7) to carry out a variety of tasks. Programs corresponding to these processes can be stored in the memory 310.

In some embodiments, the green start trigger 315 generates a signal that is transmitted to the controller 305 prior to the green start of a vehicle (see FIG. 2). After receiving the signal from the green start trigger 315, the controller 305 executes a green start process (see, for example, the process illustrated in FIG. 4) that is different from a traditional or normal start and/or running process during the green start of the vehicle. In some embodiments, the green start trigger 315 is transmitted to the controller 305 prior to the controller 305 being installed in the vehicle (e.g., during a programming process of the controller 305). In such embodiments, the controller 305 automatically executes a green start process upon the green start of the engine being initiated. In other embodiments, the green start trigger 315 can be transmitted to the controller 305 after the controller 305 has been installed in the vehicle by a user, for example, while the vehicle is being assembled. In such embodiments, the green start trigger 315 may be transmitted to the controller 305 by an assembly line worker with a diagnostic tool.

The electronically controlled fuel injectors 320 and spark plugs 325 receive signals from the controller 305 to operate. For example, the fuel injectors 320 receive a signal that controls the timing, duration, and frequency that the fuel injectors 320 are operating (e.g., injecting fuel into cylinders of an engine). Similarly, the spark plugs 325 receive a signal that controls the timing that a spark is produced. As previously described, the controller 305 must operate with fuel injectors 320 and spark plugs 325 with accuracy to ensure proper operating conditions of the engine (see, for example, the discussion regarding spark timing above).

FIG. 4 illustrates an exemplary process 400 for supporting an engine during an engine test. For example, in some embodiments, the process 400 may be a green start process that is executed by the controller 305 (see FIG. 3) during the engine's green start. The first step in the process is to prevent the engine 105 from starting using residual fuel (or a residual air/fuel mixture) that is present in the fuel rail 110 of the engine 105. As described in greater detail below, this may be accomplished by retarding a spark timing of the spark plugs 130 in the engine 105. While the engine 105 is being prevented from starting, the residual fuel in the fuel rail 110, as well as air from the fuel line 140 is purged (step 410). For example, by retarding the spark timing, the residual fuel is burned without causing the engine to start. Additionally, the fuel injectors 125 of the engine 105 continue to operate while the engine 105 is prevented from starting. The operation of the fuel injectors 125 naturally forces the air from the fuel line 140 through the fuel rail 110 until fuel from a gas tank 135 can be supplied to the fuel rail 110. In some embodiments, steps 405 and 410 occur concurrently, in that the engine is prevented from starting while the residual fuel is purged from the fuel rail.

While the engine is being started, fuel from the fuel tank 135 (and associated fuel line 140) eventually reaches the fuel rail 110 in the engine 105. Upon the fuel rail 110 being supplied with fuel from the fuel tank 135, the engine 105 is allowed to start (i.e., the engine 105 is no longer being prevented from starting) (step 415). After the engine 105 has started, the operation of the engine 105 is supported during an idling operation to prevent an engine stall (step 420). This can include, for example, altering and/or otherwise controlling spark timing, as described in greater detail below. Additionally, compensation is provided for fuel rail inconsistencies (step 425). In some embodiments, fuel rail inconsistencies can be compensated for by altering the physical orientation of the engine (e.g., the engine tilt), or by altering the operation of the fuel injectors 110 of the first bank 115 compared to the second bank 120.

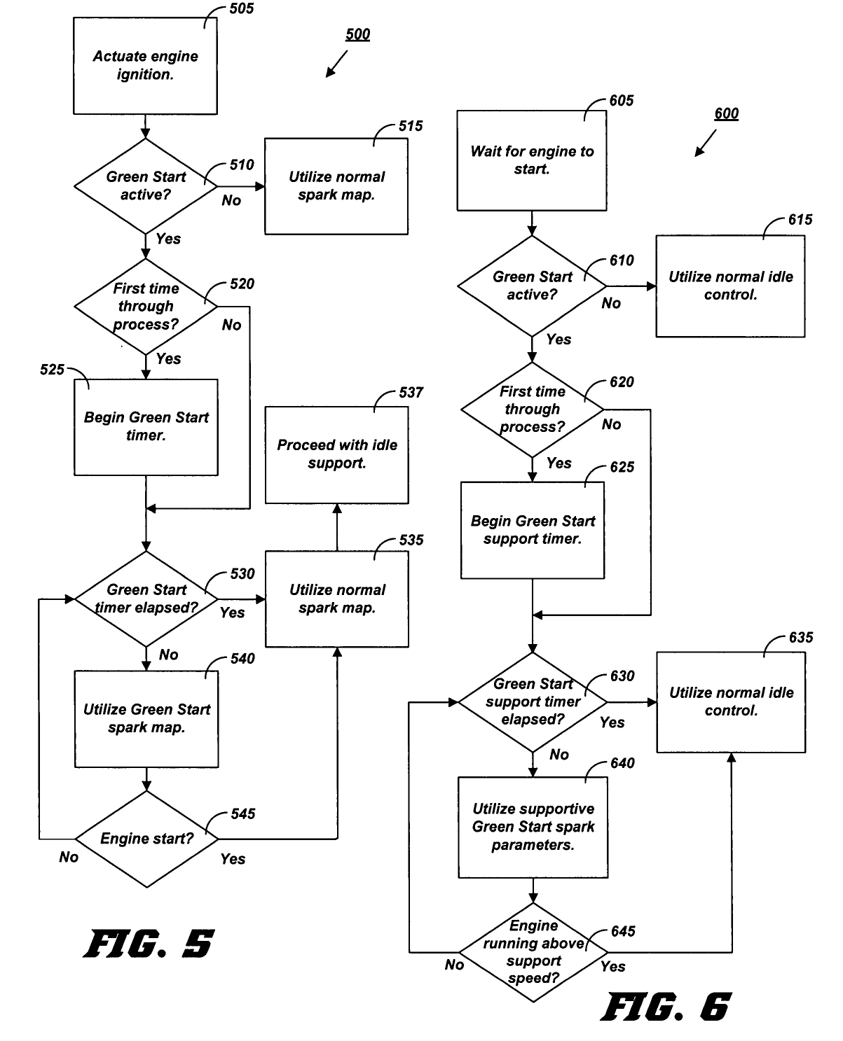

FIG. 5 illustrates an exemplary process 500 for controlling spark timing. In some embodiments, the process 500 may be implemented as a portion of a larger green start process that is executed by a controller (such as the controller 305) during an engine's initial start. For example, in some embodiments, the process 500 is a part of the process 400 (e.g., steps 405-415) (see FIG. 4). In other embodiments, the process 500 may be executed independently of the other processes described herein.

The first step in the process 500 is to initiate ignition of an engine (e.g., start the engine, for example, by turning an ignition key) (step 505). After the ignition process has been initiated, a verification is made that a green start process or procedure is active (step 510). For example, a verification is made that the engine is undergoing an initial or green start, and a green start process (different from that of a normal start process) is desired. If a green start process is not active, and/or the engine is not undergoing a green start, a normal spark timing is used (step 515).

In some embodiments, the process 500 is executed multiple times during the course of an engine's start. For example, the process 500 can be executed multiple times per second. If the green start process is active, a check is made to identify whether the process 500 has been executed during the current engine starting process (step 520). If it is the first time that the process 500 has been executed, a green start timer is initialized (step 525), and a verification is made that the green start timer has not elapsed (step 530). In some embodiments, the green start timer is of a pre-determined length that corresponds to a typical duration that is required to start the engine. For example, by the time the green start timer has expired, the engine of the vehicle should start if the engine is operating properly. If the engine does not start, a problem with the engine can be identified. In some embodiments, the green start timer is approximately four to five seconds in length. In other embodiments, the timer may be shorter or longer (e.g., three seconds, seven seconds, etc.).

If it is not the first time that the process 500 has been executed, the process 500 proceeds directly from step 520 to step 530 (e.g., the green start timer is not re-started during an engine's start). If the green start timer has elapsed, a normal spark map that includes normal spark timings for each of the one or more spark plugs of the engine is used (step 535). Additionally, in some embodiments, engine idle support is provided (step 537) (e.g., the processes shown in FIGS. 6 and 7). If the green start timer has not yet elapsed, a green start spark map that includes altered spark timings for each of the spark plugs of the engine is utilized (step 540). Implementing the green start spark map may cause spark events to be retarded from their normal timings. For example, in some embodiments, the green start spark map causes spark events to occur when pistons of the engine are positioned at TDC. In other embodiments, the green start spark map causes spark events to occur after the pistons of the engine have passed TDC (e.g., 20 degrees past TDC). By retarding the spark timing of the spark plugs, the engine is rendered less efficient and is not likely to start. This allows air and residual fuel (as previously described) to be purged from the fuel rail of the engine, and be burned by the retarded sparks without starting the engine.

In some embodiments, the green start spark map varies the spark timing according to engine speed. For example, the spark events may be retarded more when the engine is operating at low speed (e.g., 150 RPM), and less when the engine is operating at a higher speed (e.g., 600 RPM). Additionally or alternatively, the green start spark map may vary the spark timing according to engine temperature, oil temperature, engine torque, etc.

While retarding the spark timing reduces the probability that the engine will start based on residual fuel in the fuel rail, as the process 500 is repeated (and the engine continues to operate during the start process) fuel eventually reaches the fuel rail from a fuel line and a fuel tank. Accordingly, a verification is made that the engine has not started (step 545). For example, when fuel from the fuel tank reaches the fuel rail, the engine may start despite the retarded spark timing. In such instances, a normal spark map is used (step 535), and idle support may be provided (step 537). If the engine does not start, the process 500 returns to step 530 and the status of the green start timer is queried.

FIG. 6 illustrates an exemplary process for controlling the spark of a spark plug in an engine. In some embodiments, the process 600 may be implemented as a portion of a larger green start process that is executed by a controller (such as the controller 305) during an engine's initial start. For example, in some embodiments, the process 600 is a part of the step 420 in process 400 (see FIG. 4). Additionally, in some embodiments, the process 600 is executed subsequent to the completion of the process 500 (see FIG. 5). In other embodiments, the process 600 may be executed independently of the other processes described herein.

The first step in the process is to verify that an engine of the vehicle has started (step 605). After the ignition process has been initiated, a verification is made that a green start process or procedure is active (step 610). If the green start process is not active, a normal idle control is utilized (step 615). For example, a normal idle control process is allowed to vary the spark timing (e.g., adjust the spark timing closer to, or further from, TDC) to control the idle of the engine.

If the green start process is active, a check is made to identify whether the process 600 has been executed during the current engine idle (step 620). If it is the first time that the process 600 has been executed, a second or supportive green start timer is initialized (step 625), and a verification is made that the supportive green start timer has not elapsed (step 630). In some embodiments, the supportive green start timer is of a pre-determined length that corresponds to a typical duration that is required for the engine to achieve a normal and/or stable idle. For example, by the time the supportive green start timer expires, the engine should be idling at a relatively constant rate. If the engine is not idling, or is idling at sporadic speeds, a problem with the engine 105 can be identified. In some embodiments, the supportive green start timer is five to eight seconds in length. In other embodiments, the supportive spark timer may be shorter or longer (e.g., three seconds, 10 seconds, etc.).

In some embodiments, the supportive green start timer and the green start timer of FIG. 5 (see step 525) are incorporated into a single timer. For example, a single green start timer that includes one or more distinct points or flags, which can be identified during execution of the green start process (e.g., a first green start timer flag is set at approximately four seconds, and a second green start timer flag is set at approximately ten seconds).

If it is not the first time that the process 600 has been executed, the process 600 proceeds directly from step 620 to step 630 (e.g., the supportive green start timer is not re-started while the engine is idling). If the supportive green start timer has elapsed, a normal idle control of the engine is used (step 535), as described above. If the green start timer has not yet elapsed, supportive spark parameters are utilized to support the engine idle (step 640). For example, changes in spark timing are made more quickly and/or aggressively to maintain engine idle without stalling. In some embodiments, a proportional-integral “PI” control process is used to control the spark timing during engine idle. In such embodiments, the “p” parameter may be increased to increase the aggressiveness (e.g., the rate and/or amount) with which the spark timing is altered. By providing supportive spark parameters, the tendency to stall is countered.

After the engine begins to operate at a certain speed, the tendency to stall is decreased. For example, after the engine exceeds a predetermined number (e.g., 600) of revolutions per minute (“RPM”) and is relatively steady, the probability of an engine stall is relatively low. Accordingly, a verification is made that the engine is running above a speed at which idle support is required (step 645). If the speed of the engine has exceeded the speed at which idle support is needed, normal idle control parameters are implemented (step 635). If the speed of the engine has not yet exceeded the speed at while idle support is needed, the process 600 returns to step 630, and the status of the green start support timer is queried.

FIG. 7 illustrates an exemplary process for controlling the spark of a spark plug in an engine. In some embodiments, the process 700 may be implemented as a portion of a larger green start process that is executed by a controller (such as the controller 305 shown in FIG. 3) during an engine's initial start. For example, in some embodiments, the process 700 is a part of the step 420 in process 400 (see FIG. 4). Additionally, in some embodiments, the process 700 is executed subsequent to the completion of the process 500 (see FIG. 5), and/or concurrently with the process 600 (see FIG. 6). In other embodiments, the process 600 may be executed independently of the other processes described herein.

The first step in the process 700 is to verify that an engine of the vehicle has started (step 705). After the ignition process has been initiated, a verification is made that a green start process or procedure is active (step 710). If the green start process is not active, normal spark timing boundaries are utilized by an idle control process (step 715). For example, an idle control process is allowed to vary the spark timing (e.g., adjust the spark timing closer to, or further from, TDC) within a relatively broad range (e.g., 30 degrees before TDC to 30 degrees after TDC). If the green start process is active, a check is made to identify whether the process 700 has been executed during the current engine idle (step 720). If it is the first time that the process 700 has been executed, a supportive green start timer is initialized (step 725), and a verification is made that the supportive green start timer has not elapsed (step 730). Similar to the process 600, the supportive green start timer is of a pre-determined length that corresponds to a typical duration that is required for the engine to achieve a normal and/or stable idle. Thus, when the supportive green start timer expires, the engine should be idling normally. In embodiments in which the process 600 and the process 700 are executed concurrently (e.g., both the process 600 and the process 700 are initialized after the engine has started), a single green start support timer may be utilized for both of the processes. Additionally, as described above, the green start timer used in the process 700 may also be incorporated with the timer used in the process 500.

If it is not the first time that the process 700 has been executed, the process 700 proceeds directly from step 720 to step 730 (e.g., the supportive green start timer is not re-started while the engine is idling). If the supportive green start timer has elapsed, a normal idle control of the engine is used (step 735). If the green start timer has not yet elapsed, supportive spark parameters are utilized to support the engine idle (step 740). This may include, for example, providing a minimum spark boundary. For example, during idle, an idle control process may attempt to retard the spark timing, thereby initiating a stall. Implementing a minimum spark boundary limits the ability of the idle control process to retard the spark timing. By limiting the ability of the idle control process to retard the spark timing, the tendency of the engine 105 to stall is reduced. In some embodiments, the minimum spark boundary is approximately 10 degrees past TDC. In other embodiments, an alternative minimum spark boundary may be implemented (e.g., five degrees past TDC, 20 degrees past TDC, etc.).

As described above, once the engine begins to operate at a certain speed (e.g., 600 RPM), the tendency to stall is decreased. As such, an engine speed verification is executed to ensure that the engine is running above the speed at which idle support is required (i.e., a “support speed”) (step 745). If the engine speed has exceeded the support speed, normal idle control parameters are implemented (step 735). If the engine speed has not yet exceeded the support speed, the process returns to step 730, and the status of the green start support timer is queried.

FIG. 8 illustrates a front view of an exemplary engine 800. The engine 800 generally includes a fuel rail that is internal to the engine 800 having a first bank 805 and a second bank 810. In the embodiment shown, the first bank 805 is on the left side of the engine 800 (e.g., the left side of the engine 800 from the perspective of the front view), while the second bank 810 is on the right side of the engine 800 (e.g., the right side of the engine 800 from the perspective of the front view). The engine 800 is generally shown as being a “V” style engine. However, the principals described herein can be applied to a variety of types of engines.

In some instances, when the engine 800 is installed in a vehicle (such as the vehicle 100 shown in FIG. 1), the engine 800 may be slightly tipped or canted to one side (e.g., with respect to the “y” axis). In the embodiment shown in FIG. 8, the engine 800 is canted approximately four degrees from the y axis. As a result, the first bank 805 is positioned relatively lower than the second bank 810. Positioning the first bank 805 lower than the second bank 810 makes air in the fuel rail more susceptible to being located in the second bank 810, rather than being equally distributed between the first bank 805 and the second bank 810. Accordingly, when the air is purged from the fuel rail during an initial or green start (described above), the final amount of air remaining in the fuel rail is naturally positioned in the second fuel rail 810, while the first fuel rail 805 is filled with fuel (e.g., fuel supplied from a fuel tank). This can lead to fuel injectors associated with the first bank 805 to inject more fuel (e.g., approach a “rich” burning limit), and fuel injectors associated with the second bank 810 to inject a combination of fuel and air (e.g., burn more “lean”). Fuel injection inconsistencies between bank 805 and bank 810 can result in a poorly operating engine (e.g., an engine susceptible to stall).

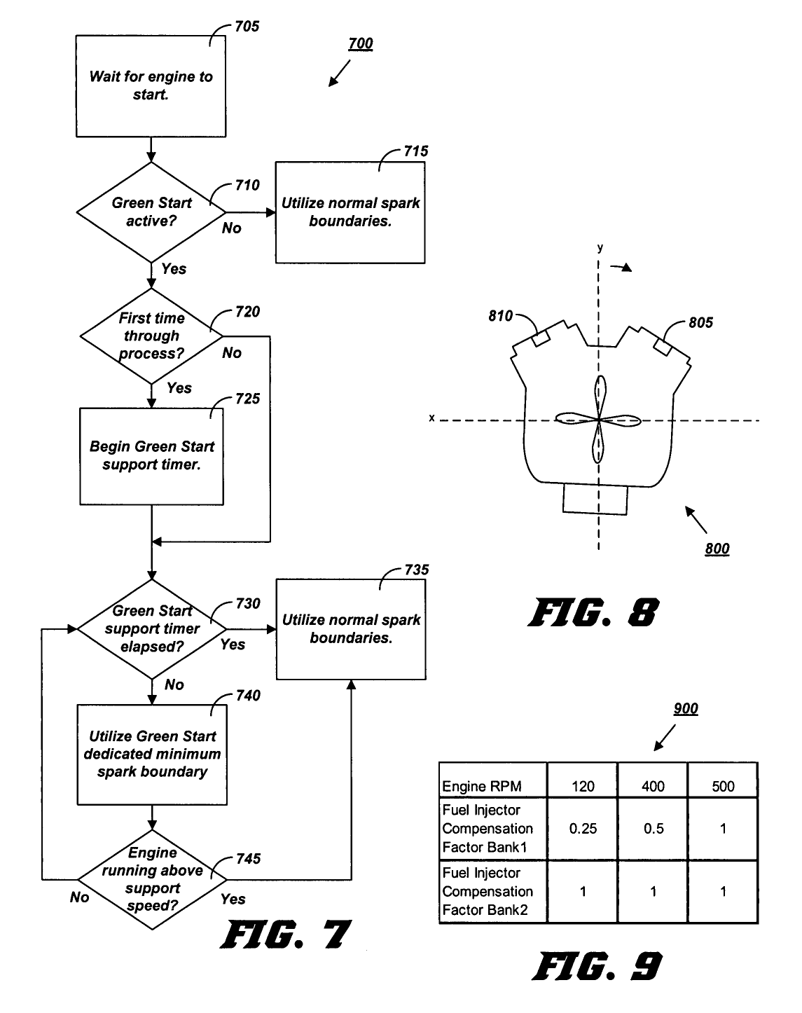

FIG. 9 illustrates an exemplary table 900 of fuel injection ratios. The fuel injection ratio table 900, in some embodiments, can be applied to the engine 800 (and associated fuel injectors) shown in FIG. 8. For example, the table 900 illustrates a scheme in which an amount that the fuel injectors are open (or active) is altered according to a speed with which the engine 800 operates. To counteract an unequal fuel injection between fuel rail banks (i.e., the first bank 805 and the second bank 810), the fuel injectors associated with the first bank 805 are controlled differently than the fuel injectors associated with the second bank 810.

In the embodiment shown in FIG. 9, the operation of the fuel injectors associated with the first bank 805 is altered as the engine speed increases. Alternatively, the fuel injectors associated with the second bank 810 do not include an operational compensation (i.e., the fuel injectors associated with the second bank 810 operate at the normal or full rate despite changing engine speed). This allows air to be purged from the fuel rail without the fuel inconsistencies described above. As shown in the table 900, the fuel injectors associated with the first bank 805 initially operate at approximately 25 percent of a normal rate. After the engine speed exceeds a first speed threshold (e.g., 120 RPM), the rate of operation of the fuel injectors associated with the first bank 805 increases to approximately 50 percent of a normal rate. Additionally, after the engine speed exceeds a second speed threshold (e.g., approximately 400 RPM), the rate of operation of the fuel injectors associated with the first bank 805 increases to a normal or full rate. In the embodiment shown in FIG. 9, when the engine speed reaches a third threshold (e.g., 500 RPM), compensation between banks (the first bank 805 and the second bank 810) is no longer required.

In the embodiment shown in FIG. 9, if the engine 800 is operating above approximately 500 RPM, it is assumed that compensation is no longer required (e.g., all the air has been purged from the fuel rail and fuel is being supplied to the fuel rail from the fuel tank). However, in other embodiments, the speed of the engine and corresponding compensation may be altered. For example, in some embodiments, compensation between fuel rail banks may be desired until the engine is operating with a higher speed than 500 RPM (e.g., 600 RPM, 900 RPM, etc.). Additionally, a greater number of speed intervals may be included, with additional corresponding compensation ratios for each speed interval.

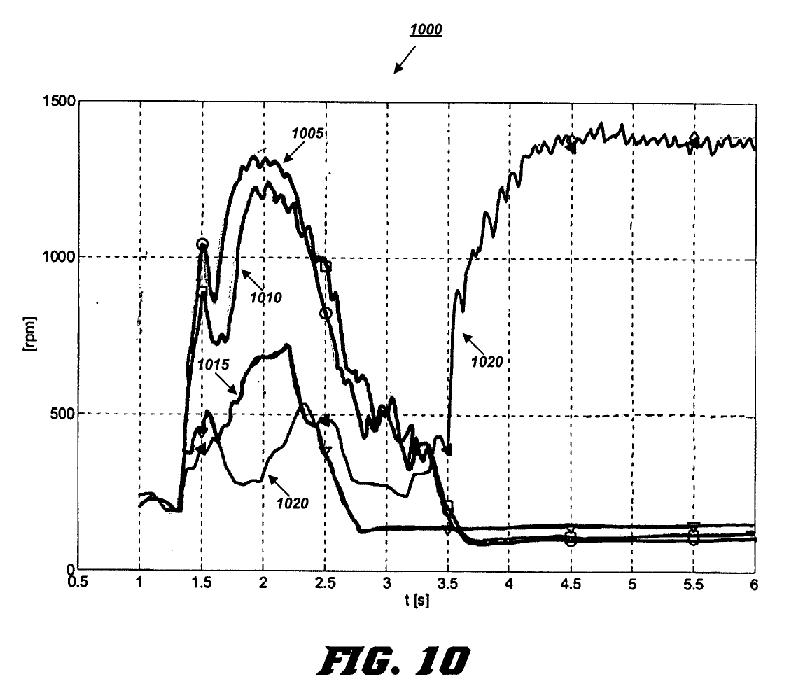

FIG. 10 illustrates an exemplary plot 1000 of engine revolutions per minute (“RPM”) over time. The plot 1000 includes a first trace 1005, a second trace 1010, a third trace 1015, and a fourth trace 1020, each of which represent an engine starting (and subsequent idling) event. The first trace 1005 and the second trace 1010 are indicative of an engine that starts initially, represented by the relatively large spike from approximately 200 RPM to 1200 RPM, but that subsequently stalls, represented by the decline and eventual leveling from the 1200 RPM peak to about zero RPM. This type of initial-start-to-stall event can occur, for example, when an engine starts based on residual fuel in the fuel rail. As previously described, the engine starts initially, but soon stalls as air from the fuel rail and fuel line associated with the fuel system bleeds through fuel injectors of the engine. The trace 1015, although not as drastic, indicates a similar pattern. For example, after reaching approximately 700 RPM the engine detects a start, and the engine soon stalls due to air being purged from the fuel rail and/or fuel lines.

The trace 1020 indicates an engine that does not start initially (represented by the relatively low engine RPM for the first three and a half seconds of operation, barely exceeding 500 RPM), but eventually starts (represented by the RPM ascent) and reaches an idle of approximately 1400 RPM. The trace 1020 can be produced, for example, using a green start process similar to that shown in FIG. 4. For example, the engine is prevented from starting by retarding the spark timing. While the spark timing is being retarded, residual fuel in the fuel rail is burned and air is purged from the fuel system. Then, upon fuel being supplied to the fuel rail by the fuel system, the spark timing is advanced and the engine is allowed to start. Upon the engine being successfully started, idle is supported (e.g., using supportive spark parameters and/or boundaries) to maintain relatively even and strong running of the engine. Additionally, the tendency to stall can be compensated for by controlling the operation of the fuel injectors.

Various features and embodiments of the invention are set forth in the following claims.

What is claimed is:

1. A method of starting an engine having a fuel rail, one or more fuel injectors, and one or more spark plugs, the method comprising:
initializing a starting operation of the engine;
suppressing the engine from starting by retarding a spark timing of the one or more spark plugs from normal spark timing;
purging, while the spark timing is being retarded, the fuel rail of the engine by operating the one or more fuel injectors; and
advancing the spark timing after a first duration has passed or the engine has started.

2. The method of claim 1, further comprising supporting an idle operation of the engine after the engine has started by altering spark parameters of the one or more spark plugs.

3. The method of claim 2, further comprising supporting the idle operation of the engine until the engine is operating at a pre-determined operating speed or a second duration has passed.

4. The method of claim 2, further comprising altering spark parameters by increasing a rate with which spark timing is altered.

5. The method of claim 2, further comprising altering spark parameters by setting a minimum spark boundary of the one or more spark plugs.

6. The method of claim 1, further comprising supporting an idle operation of the engine by compensating for fuel supply deviations between a first bank of the fuel rail and a second bank of the fuel rail.

7. The method of claim 6, wherein compensating for fuel supply deviations includes operating fuel injectors associated with the first bank differently than fuel injectors associated with the second bank.

8. The method of claim 1, wherein retarding the spark timing includes utilizing a green start spark map, the green start spark map varying with engine speed.

9. A method of starting an engine having a fuel injection system, the engine being installed in a vehicle having an associated fuel line and fuel tank, the fuel injection system and fuel line being initially substantially air filled, the method comprising:
initializing a starting operation of the engine;
retarding a spark timing of one or more spark plugs included in the fuel injection system;
purging air from of the fuel line and burning residual fuel from the fuel rail;
supplying the fuel rail with fuel from the fuel tank via the fuel line; and
advancing the spark timing of the one or more spark plugs included in the fuel injection system upon the engine of the vehicle starting based on fuel delivered to fuel injectors of the fuel injection system from the fuel tank of the vehicle.

10. The method of claim 9, further comprising advancing the spark timing of the one or more spark plugs included in the fuel injection system upon exhaustion of a first pre-determined duration.

11. The method of claim 10, further comprising altering spark parameters, after the engine has started, by increasing an aggressiveness with which the spark timing is altered or or by setting a minimum spark boundary of the one or more spark plugs.

12. The method of claim 9, further comprising supporting an idle operation of the engine by compensating for fuel supply deviations between a first bank of the fuel rail and a second bank of the fuel rail.

13. The method of claim 12, wherein compensating for fuel supply deviations includes operating fuel injectors associated with the first bank differently than fuel injectors associated with the second bank.

14. The method of claim 13, further comprising altering the compensation for fuel supply deviations based at least partially on engine speed.

15. The method of claim 9, further comprising retarding the spark timing using a spark map based at least partially on engine speed and engine temperature.

16. A method of starting an engine of a vehicle, the engine having a fuel injection system, the vehicle having a fuel tank and a fuel line that is configured to supply the fuel injection system of the engine with fuel from the fuel tank, the method comprising:
initiating a green start process, the green start process being different from a normal start process;
actuating an ignition operation of the engine;
retarding a spark timing of spark plugs included in the engine for a first duration;
advancing the spark timing upon the first duration being exhausted;
starting the engine of the vehicle upon the spark timing being advanced; and
supporting an idle operation of the engine by altering spark parameters of the spark plugs.

17. The method of claim 16, further comprising altering spark parameters by increasing an aggressiveness with which spark timing is altered.

18. The method of claim 16, further comprising altering spark parameters by setting a minimum spark boundary of the one or more spark plugs.

19. The method of claim 16, further comprising supporting the idle operation of the engine by compensating for fuel supply deviations between a first bank of the fuel rail and a second bank of a fuel rail included in the fuel injection system.

20. The method of claim 19, wherein compensating for fuel supply deviations includes operating fuel injectors associated with the first bank differently than fuel injectors associated with the second bank.
